(19) United States
(12) Patent Application Publication
(10) Pub. No.: US 2010/0037771 A1
(43) Pub. Date: Feb. 18, 2010

(54) METHOD AND PLANT FOR CO2 ENRICHMENT

(75) Inventors: Tor Christensen, Sandefjord (NO); Henrik Fleischer, Slependen (NO); Knut Børseth, Sandefjord (NO)

Correspondence Address: BIRCH STEWART KOLASCH & BIRCH, PO BOX 747, FALLS CHURCH, VA, 22040-0747, US

(73) Assignee: SARGAS AS, Oslo (NO)

(21) Appl. No.: 12/594,686

(22) PCT Filed: Apr. 4, 2008
(86) PCT No.: PCT/NO2008/000128

§ 371 Date: Oct. 5, 2009

(30) Foreign Application Priority Data
Apr. 4, 2007 (NO) 20071772

(51) Int. Cl. B01D 53/24; B01D 53/14; B01D 53/73; B01D 53/75; B01D 51/10

(52) U.S. Cl. 95/35; 95/34; 55/345; 55/343; 96/301

(57) ABSTRACT

The present invention relates to a method and a plant for CO₂ enrichment of a CO₂ containing gas, such as an exhaust gas from an industrial plant or a thermal power plant, by means of serially connected centrifuges of cyclones. Enrichment of CO₂ reduces the volume of the exhaust gas, increases the partial pressure of CO₂ therein and makes a less expensive and more effective capture of CO₂ possible. The invention also relates to plants for carrying out the method.

### THE FIELD OF THE INVENTION

The present invention relates to a method and a plant for CO₂ enrichment of a CO₂ containing gas. More specifically, the present invention relates to a method and a plant for increasing enrichment of CO₂, or for increasing the partial pressure of CO₂ in a gas stream comprising CO₂ in combination with other gases, such as flue gases from industrial processes and combustion of fossil fuels, to make a subsequent CO₂ capturing more efficient. The invention also relates to a method and a plant for capturing CO₂ from a CO₂ containing gas including said method and plant for CO₂ enrichment.

### BACKGROUND

The concentration of CO₂ in the atmosphere has increased by nearly 30% in the last 150 years. The concentration of methane has doubled and the concentration of nitrogen oxides has increased by about 15%. This has increased the atmospheric greenhouse effect, something which has resulted in:
The mean temperature near the earth's surface has increased by about 0.5° C. over the last one hundred years, with an accelerating trend in the last ten years.
Over the same period rainfall has increased by about 1%
The sea level has increased by 15 to 20 cm due to melting of glaciers and because water expands when heated up.

Increasing discharges of greenhouse gases is expected to give continued changes in the climate. Temperature can increase by as much as 0.6 to 2.5° C. over the coming 50 years. Within the scientific community, it is generally agreed that increasing use of fossil fuels, with exponentially increasing discharges of CO₂, has altered the natural CO₂ balance in nature and is therefore the direct reason for this development.

It is important that action is taken immediately to stabilize the CO₂ content of the atmosphere. This can be achieved if CO₂ generated in a thermal power plant is collected and deposited safely. It is assumed that the collection represents three quarters of the total costs for the control of CO₂ discharges to the atmosphere.

Thus, an energy efficient, cost efficient, robust and simple method for removal of a substantial part of CO₂ from the discharge gas will be desirable to ease this situation. It will be a great advantage if the method can be realized in the near future without long-term research.

Discharge gas from thermal power plants typically contains 4 to 10% by volume of CO₂, where the lowest values are typical for gas turbines, while the highest values are only reached in combustion chambers with cooling, for example, in production of steam.

There are three opportunities for stabilizing the CO₂ content in the atmosphere. In addition to the capturing of CO₂, non-polluting energy sources such as biomass can be used, or very efficient power plants can be developed. The capturing of CO₂ is the most cost efficient. Still, relatively little development work is carried out to capture CO₂, the methods presented up till now are characterized either by low efficiency or by a need for much long-term and expensive development. All methods for capturing CO₂ comprise one or more of the following principles:
Absorption of CO₂. The exhaust gas from the combustion is brought into contact with an amine solution, at near atmospheric pressure. Some of the CO₂ is absorbed in the amine solution which is then regenerated by heating. The main problem with this technology is that one operates with a low partial pressure of CO₂, typically 0.04 bar, in the gas which shall be cleaned. The energy consumption becomes very high (about 3 times higher than if it is cleaned with a CO₂ partial pressure of 1.5 bar). The cleaning plant becomes expensive and the degree of cleaning and size of the power plant are limiting factors. Therefore, the development work is concentrated on increasing the partial pressure of CO₂. An alternative is that the exhaust gas is cooled down and re-circulated over the gas turbine. The effect of this is very limited due to the properties of the turbine, among other things. Another alternative is that the exhaust gas which is to be cooled down, is compressed, cooled down again, cleaned with, for example, an amine solution, heated up and expanded in a secondary gas turbine which drives the secondary compressor. In this way, the partial pressure of CO₂ is raised, for example to 0.5 bar, and the cleaning becomes more efficient. An essential disadvantage is that the partial pressure of oxygen in the gas also becomes high, for example 1.5 bar, while amines typically degrade quickly at oxygen partial pressures above about 0.2 bar. In addition, costly extra equipment is required. Other combinations of primary and secondary power stations exist.
Air separation. By separating the air that goes into the combustion installation into oxygen and nitrogen, circulating CO₂ can be used as a propellant gas in a power plant. Without nitrogen to dilute the CO₂ formed, the CO₂ in the exhaust gas will have a relatively high partial pressure, approximately up to 1 bar. Excess CO₂ from the combustion can then be separated out relatively simply so that the installation for collection of CO₂ can be simplified. However the total costs for such a system becomes relatively high, as one must have a substantial plant for production of oxygen in addition to the power plant. Production and combustion of pure oxygen represent considerable safety challenges, in addition to great demands on the material. This will also most likely require development of new turbines.
Conversion of the fuel. Hydrocarbon fuels are converted (reformed) to hydrogen and CO₂ in pressurized processing units called reformers. The product from the reformers contains CO₂ with a high partial pressure so that CO₂ can be separated out and deposited or used in another way. Hydrogen is used as fuel. The total plant becomes complicated and expensive, as it comprises a hydrogen-generating plant and a power plant.

A common feature of the alternative methods for capture of CO₂ from a power plant is that they strive for a high partial pressure of CO₂ in the processing units where the cleaning is carried out. In addition, alternative methods are characterized by long-term, expensive and risky developments, with a typical time frame of 15 years research and a further 5 to 10 years or more before operating experience is attained. Expected electrical efficiency for large turbines under test conditions and full load, are up to 56 to 58%, whereas the efficiency under normal operating conditions with part load and degeneration of turbines, is about 52 to 54%, for a plant without cleaning. Expected efficiency for a plant including CO₂ capturing is expected to be below 40%.

An extended time frame is enviromnentally very undesirable. In a United Nations Economic Commission for Europe (UNECE) conference in the autumn of 2002, “an urgent need to address the continuing exponential rise in global CO₂ emissions” was emphasised and words such as “as soon as possible” and “need to go far beyond Kyoto protocol targets” were used.

Capturing of CO₂ from a gas by means of absorption seems to be the most promising solution at least for providing an effective capturing of CO₂ at a short to medium time horizon. Accordingly, substantial efforts have been made to increase the efficiency, and reduce the cost for CO₂ capturing.

Important issues in capturing CO₂ by absorption are the large volume of gas that is to be treated and the relative low partial pressure of CO₂ normally present in combustion gases. The exhaust gas from a gas fired power plant of 400 MW constitutes about 1000 m³/sec at atmospheric pressure, and the CO₂ partial pressure is about 0.004. Due to the low partial pressure of CO₂ only high capacity absorbents, such as amines, may be used. The amine absorbents will be degraded in the presence of oxygen, that are present in the exhaust gas at a partial pressure of typically about 0.14, to form toxic waste. Additionally, amines will be released to the atmosphere.

WO 2005/045316, which is included as reference in its entirety, to the present inventors, relates to a method for separation of CO₂ from the combustion gas from a thermal power plant fired with fossil fuel, and a plant for performing the method, the method comprising the steps of:

a) cooling and mixing the combustion gas from the thermal power plant with air;

b) compressing the combustion gas—air mixture;

c) reheating the compressed gas from step b) by using it as an oxygen containing gas for combustion of natural gas in a pressurized combustion chamber to form an exhaust gas;

d) regulating the supply of natural gas and oxygen containing gas in the combustion chamber so that the exhaust gas contains less than 6% rest oxygen;

e) keeping the temperature in the exhaust gas between 700 and 900° C. by generation of steam in tubular coils in the combustion chamber;

f) cooling the the exhaust gas and bringing it in contact with an absorbent absorbing CO₂ from the exhaust gas to form a low CO₂ stream and an absorbent with absorbed CO₂;

g) heating the low CO₂ stream by means of heat exchanges against the hot exhaust gas leaving the combustion chamber; and

h) expanding the heated low CO₂ stream in turbines.

The total volume of the incoming combustion gas from the thermal power plant, and the relative low content of CO₂ therein, add both investment cost and energy cost during operation of the plant.

The use of centrifugal forces for separation of gases having different molecular weight, is known. WO 2005/049175 describes the use of cyclone separators for separation gaseous mixtures comprising at least two gases having different molecular weight. U.S. Pat. No. 6,363,923 relates to a use of a centrifuge for oxygen enrichment for air for an internal combustion engine. U.S. Pat. No. 6,716,269 relates to a centrifuge and a cascade of centrifuges for separation of gases, more specifically, the publication relates to separation CO₂ and other heavy gases, such as H₂S, from methane in produced natural gas. The separated heavy gases may be further treated and/or deposited. Additionally, centrifuges have been used for decades for separation of Uranium 235 and Uranium 238.

An object of the present invention is to improve CO₂ capturing from gases comprising CO₂. Other objects will be clearer after reviewing the present description and claims.

### SUMMARY OF THE INVENTION

According to a first aspect, the present invention relates to a method for enrichment of CO₂ from a gas mixture comprising at least CO₂ and nitrogen, comprising the steps of:
a) introducing the gas mixture into a centrifugal separation device separating the gas mixture based on the molecular weight of the gases therein in a centrifugal field created by rotation of the gas mixture about an axis of rotation in a centrifuge or cyclone,
b) withdrawing a low CO₂ stream close to the axis of rotation and a CO₂ enriched stream is withdrawn close to the periphery of rotation,
c) releasing the low CO₂ stream into the surroundings,
d) introducing the stream enriched in CO₂ from one centrifuge or cyclone into a next centrifuge or cyclone, and
e) withdrawing a low CO₂ stream, that is released to the surroundings, and a CO₂ enriched stream from this next centrifuge or cyclone.

The large gas volume and low concentration of CO₂ are two main obstacles in the capture of CO₂ from industrial plants and thermal power plants. Enrichment of CO₂ from a CO₂ containing gas before capturing the CO₂ makes it possible to achieve a more efficient and less expensive capture of CO₂ from the exhaust gas.

Steps d) and e) may repeated one or more times to allow for a higher degree of enrichment of CO₂ to reduce the volume of the gas and to increase the partial pressure, or concentration of CO₂, in the gas to be treated during the CO₂ capturing process, to increase the efficiency of the capturing process even more.

According to a second aspect, the present invention relates to method for separation of CO₂ from a gas mixture comprising at least CO₂ and nitrogen, comprising the steps of:
a) introducing the gas mixture into a centrifugal separation device separating the gas mixture based on the molecular weight of the gases therein in a centrifugal field created by rotation of the gas mixture about an axis of rotation in a centrifuge or cyclone,
b) withdrawing a low CO₂ stream close to the axis of rotation and a CO₂ enriched stream is withdrawn close to the periphery of rotation,
c) releasing the low CO₂ stream into the surroundings,
d) introducing the stream enriched in CO₂ from one centrifuge or cyclone a next centrifuge or cyclone,
e) withdrawing a CO₂ low stream, that is released into the surroundings, and
f) withdrawing a CO₂ enriched stream,
g) introducing the CO₂ enriched stream into a absorption device for separation into a CO₂ lean gas that is released into the surroundings, and CO₂.

According to this third aspect the method according to the first aspect is included in a method for capturing CO₂, and this method includes all the advantages of this overall method.

According to third aspect the invention relates to a method for separation of CO₂ from a gas mixture comprising at least CO₂ and nitrogen, comprising the steps of:
a) introducing the gas mixture into a centrifugal separation device separating the gas mixture based on the molecular weight of the gases therein in a centrifugal field created by rotation of the gas mixture about an axis of rotation in a centrifuge or cyclone,
b) withdrawing a low CO₂ stream close to the axis of rotation and a CO₂ enriched stream is withdrawn close to the periphery of rotation,
c) releasing the low CO₂ stream into the surroundings,
d) introducing the stream enriched in CO₂ from one centrifuge or cyclone a next centrifuge or cyclone,
e) withdrawing a CO₂ low stream, that is released into the surroundings, and
f) withdrawing a CO₂ enriched stream,
g) cooling and mixing the CO₂ enriched stream with air and/or oxygen;
h) compressing the combustion gas—air/oxygen mixture;
i) reheating the compressed gas from step h) by using it as an oxygen containing gas for combustion of natural gas in a pressurized combustion chamber to form an exhaust gas;
j) regulating the supply of natural gas and oxygen containing gas in the combustion chamber so that the exhaust gas contains less than 6% rest oxygen;
k) keeping the temperature in the exhaust gas below 400° by generation of steam in tubular coils in the combustion chamber;
   f) cooling the exhaust gas and separating the exhaust gas into a CO₂ depleted stream and CO₂.

According to this third aspect, the method of the first aspect is included in another method of capturing of CO₂ than the one mentioned in the second aspect.

According to the fourth aspect, the present invention relates to a plant for enrichment of CO₂ from a gas comprising nitrogen and CO₂, the plant comprising two or more centrifuges or cyclones separating the gas based on the molecular weight thereof in a centrifugal field, means to withdraw and release into the surroundings, a low molecular weight, or low CO₂ stream close to the axis of rotation of the axis of rotation of the centrifugal field, and means to withdraw a CO₂ enriched stream from the periphery of the centrifugal field, and means to transfer the CO₂ enriched stream from one centrifuge or cyclone to a next centrifuge or cyclone in a serially connected row of two or more centrifuges or cyclones, and means to withdraw the CO₂ enriched gas stream from the last centrifuge or cyclone in the row of serially connected centrifuges or cyclones and transfer the gas to means for further treatment.

According to one embodiment, the plant comprises two or more rows or serially connected centrifuges or cyclones arranged in parallel. Arranging the centrifuges or cyclones in parallel makes it possible to increase the capacity of the enrichment plant.

According to a fifth embodiment, the invention relates to a plant for capturing, or separating, CO₂ from a CO₂ containing gas, the plant comprising a plant as described for the forth embodiment, for enrichment of CO₂ and absorption means to separate the CO₂ enriched gas into a CO₂ depleted stream that is released to the surroundings, and CO₂.

According to a sixth aspect, the invention relates to a plant for capturing, or separating, CO₂ from a CO₂ containing gas, the plant comprising a plant according to the forth embodiment, for enrichment of CO₂, means for cooling and mixing the CO₂ enriched stream with air and/or oxygen, means for compressing the combustion gas—air/oxygen mixture; a combustion chamber for reheating the compressed gas by using it as an oxygen containing gas for combustion of natural gas in a pressurized combustion chamber to form an exhaust gas; means for regulating the supply of natural gas and oxygen containing gas in the combustion chamber so that the exhaust gas contains less than 6% rest oxygen; tubular coils arranged in the combustion chamber for keeping the temperature in the exhaust gas below 400° by generation of steam in the tubular coils; means for cooling the exhaust gas; and absorption means for separating the exhaust gas into a CO₂ depleted stream and CO₂.

### SHORT DESCRIPTION OF THE FIGURES

FIG. 1 is a sectional view of a centrifuge,

FIG. 2 is a cross section A-A in FIG. 1,

FIG. 3 is a sectional view of a series of centrifuges,

FIG. 4 is an exemplary plant including the present enrichment plant, and

FIG. 5 is an alternative exemplary plant including the present enrichment plant.

### DETAILED DESCRIPTION OF THE INVENTION

Gases having different molecular weights will be separated, at least partly, by a strong gravitational field caused by e.g. a centrifuge or a cyclone separator. A typical gas to be treated according to the present invention is combustion gas from a thermal power plant, or a CO₂ containing industrial waste gas. Combustion gas mainly comprises N₂, O₂, and CO₂ having molecular weights of about 28, 32 and 44, respectively. In a strong gravitational field in a centrifuge or a cyclone, the heavier molecules, i.e. CO₂, will migrate towards the periphery of the centrifugal field whereas the lighter molecules, N₂ and O₂ will migrate towards the longitudinal axis of the centrifuge or cyclone. Minor amounts of water remaining in the combustion gas after cooling and condensation, having a molecular weight of 16, will migrate towards the axis of rotation.

Accordingly, by exposing the combustion gas for a centrifugal separation step, N₂ and O₂ being the lighter molecules in the combustion will be enriched along the longitudinal axis of the centrifugal field and a CO₂ depleted gas may be withdrawn from an outlet close to the axis of rotation. CO₂ will be enriched towards the periphery of the centrifugal, and a CO₂ enriched gas may be withdrawn from the periphery of the centrifuge or cyclone. The CO₂ depleted gas may be released into the air, whereas the CO₂ enriched gas, being substantially reduced in volume, preferably is further processed.

The present invention will now be illustrated based on centrifuges but the principle applies correspondingly for cyclones.

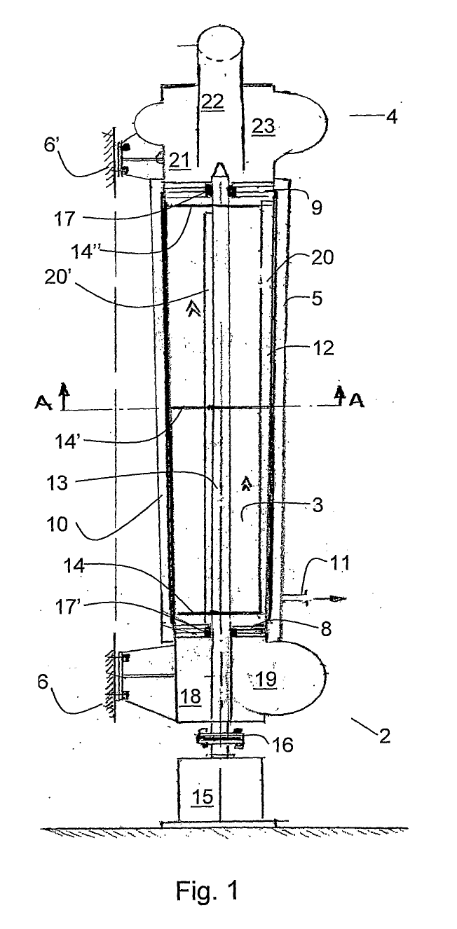

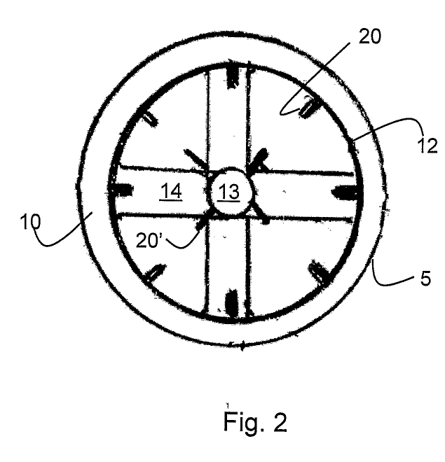

FIG. 1 is a longitudinal section of a centrifuge 1 for CO₂ enrichment, whereas FIG. 2 is a cross section along A-A in FIG. 1. The centrifuge comprises three main parts, an inlet static body 2, a rotary part 3 and an outlet static body 4. The inlet and outlet static bodies 2, 4 are fastened to supports 6, 6′. The rotary part 3 is rotary connected to both the inlet and outlet static bodies 2, 4. Labyrinth packings 8, 9 are provided in the rotary connections between the rotary body and the static bodies to make the rotary connections substantially gas tight.

The inlet and outlet static bodies 2, 4 are preferably additionally connected by means of an outer shell 5 surrounding the rotary part 5. An annular space 10 is created between the rotary part 3 and the shell 5. The annular space 10 is closed towards the inlet and outlet parts 2, 4. The annular space 10 is preferably evacuated to reduce the friction towards the rotating part 3, by withdrawing gas from the annular space through a vacuum pipe 11. The gas withdrawn from the annular space is gas that has leaked through the labyrinth packings at the periphery of the centrifuge, and is thus is CO₂ rich and is combined with the CO₂ rich gas for further treatment.

The rotary part 3 comprises an outer tubular body 12 that is connected to an axial shaft 13 by means of rods 14, 14″, 14′″. The shaft 13 is rotated by means of a motor 15 that is connected to the axial shaft 13 via a dampening connection 16. The shaft 13 is connected to the inlet and outlet static parts, respectively, by means of bearings 17, 17′.

According to the embodiment illustrated in FIG. 1, the diameter of the shaft 13 is gradually increasing from the inlet end of the centrifuge, to have a diameter of about 50% of the diameter of the outer tubular body at a distance of about 25% from the inlet end of the centrifuge. The diameter of the shaft is thereafter gradually reduced to the same diameter as in the inlet end at a distance of about 50% from the inlet end of the centrifuge. The gas entering the centrifuge is accelerated to the rotating speed of the centrifuge in the lower part thereof. Due to the increasing diameter of the shaft, all the gas will be forced outwards from the axis of the centrifuge by the shaft. When the diameter of the shaft again is reduced, the heavier components of the exhaust gas, mainly CO₂, will remain close to the outer tubular body, whereas the lighter components, i.e. nitrogen and oxygen, will flotate in the gravitational field of the centrifuge and thus migrate towards the center to cause a separation of the gases.

The inlet static part 2, comprises a substantially cylindrical inlet chamber 18 and an inlet pipe 19 introducing the gas to be separated substantially tangential into the inlet chamber 18 to cause the gas to rotate therein. The gas in the inlet chamber 18 is then introduced into the rotating part wherein the gas is further accelerated due to the rotation of the rotating part. Longitudinal frames 20, 20′ are preferably provided at the inside of the tubular body 12 and on the shaft 38, to ensure that the gas in the rotating part is rotated by the rotation of the rotating part.

After partly separation of constituents of the gas in the rotating part, the gas is introduced into a substantially cylindrical outlet chamber 21 in the outlet part 4. A light gas outlet pipe 22 is provided substantially radial in the outlet chamber to withdraw the gas in a zone being closest to the axis of rotation of the rotating part and the rotating gas. A heavy gas outlet pipe 23 is provided substantially tangential to the outlet chamber to avoid disturbing the gas flow in the outlet chamber.

The tubular part 12 is preferably substantially conical, having its smallest diameter towards the inlet part 2, and its greatest diameter towards the outlet part. The conical shape will result in a gradually increased angular velocity of the flue gas with distance from the inlet end of the rotary part, thus reducing the risk of cavitations and reduce the power demand. The diameter of the light gas outlet pipe 22 is adjusted to be able to withdraw a controlled amount of the total gas volume. The diameter of the light gas outlet pipe and thus the part of the total gas that is withdrawn, depends on the design criteria, for the centrifuge, such as total gas volume, axial flow velocity, the composition of the introduced gas, etc. The opening area of the light gas outlet may thus be from about 10% to about 80%, such as e.g. from about 15 to about 70%, of the total area at the outlet chamber 21.

Two or more centrifuges are preferably serially connected, so that the gas leaving the first centrifuge through the heavy gas outlet pipe 23 is introduced into the inlet pipe of the next centrifuge. The gas withdrawn through the light gas outlet pipe, may for a combustion gas, be released into the atmosphere. When two or more centrifuges are serially connected, a portion of the gas is reduced for each centrifuge. The reduced volume of gas from one centrifuge to the next will result in a reduced axial velocity and an increased separation retention time. Accordingly, the separation is more efficient in the last centrifuge than in the previous ones for identical centrifuges.

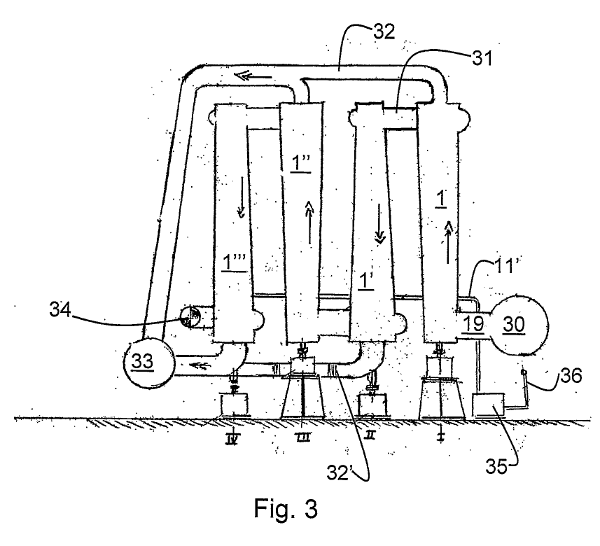

FIG. 3 illustrates four serially connected centrifuges 1, 1′, 1″ and 1′″ for CO₂ enrichment. Gas containing CO₂, such as combustion gas from a thermal power plant, is introduced through a flue gas manifold 30 that is connected to the inlet pipe 19 of the first centrifuge 1. CO₂ enriched gas withdrawn from the first centrifuge 1 is introduced into the second centrifuge 1′ through a connection line 31, whereas the light gas is withdrawn into a light gas withdrawal line 32.

The second centrifuge 1′ is correspondingly connected to the third centrifuge and a light gas withdrawal line 32′, and so on. The light gas withdrawn from a series of centrifuges through lines 32, 32′ is collected in a light gas manifold 33 and may be released into the atmosphere. The heavy gas from the last centrifuge in a series, 1′″, is withdrawn trough a manifold for CO₂ enriched gas 34.

A vacuum pipe 11′ connects the vacuum pipes 11 from each of the centrifuge units with a vacuum pump 35. The gas withdrawn through lines 11 is rich in CO₂ as the gas leaking into the annular space 10 comprises the heavy gas closest to the tubular body 12. The gas from the vacuum pump is therefore preferably connected to the manifold for CO₂ enriched gas 34, and further treated.

To increase the capacity of the separation, two or more serially connected centrifuges as illustrated above may be arranged parallel.

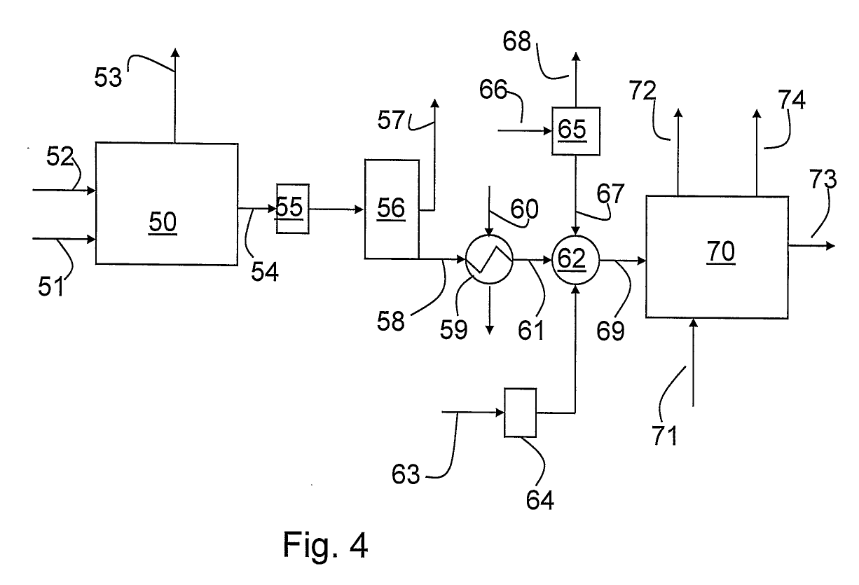

FIG. 4 illustrates a CO₂ enrichment plant integrated into a plant as described in the above identified WO 2005/045316, which is included as reference in its entirety, in which added features is introduced to reduce costs both for investments and during operation of the plant.

Fuel and oxygen containing gas, such as air, are introduced into a thermal power plant 50 through a fuel line 51 and an air line 52, respectively. The power plant may be any traditional thermal power plant for combustion of carbonaceous fuel to generate electrical power and/or heat that is exported from the plant in line(s) 53. The power plant 50 may be fired with fossil fuels, such as natural gas or coal, or any other carbonaceous fuel, or a combination of different carbonaceous fuels. Alternatively, the thermal power plant may be substituted by an industrial process emitting CO₂.

Combustion gas from the power plant 50, leaves through a combustion gas line 54 and is introduced into a combustion gas blower 55 to compensate for pressure drop in the system. The gas leaving the combustion gas blower is introduced into a combustion gas separator unit 56. In the combustion gas separator unit 56, the combustion gas is separated by means of centrifugal fields, such as by using centrifuges as described above in more detail above with reference to FIGS. 1, 2 and 3, into a CO₂ depleted fraction which is released into the atmosphere through a line 57, and a CO₂ enriched fraction that is withdrawn through a line 58.

The gas leaving the combustion gas separation unit through line 58 is introduced into a cooler in which the combustion gas is cooled against a cooling medium that is introduced through a line 60. The cooled and CO₂ enriched combustion gas is withdrawn from the cooler 59 in a line 61 and is introduced into a mixer 62, in which the CO₂ enriched combustion gas is mixed with an oxygen containing gas, such as air through a line 63, oxygen or oxygen enriched air through line 67. Two different options for introduction of the oxygen containing gas are illustrated in FIG. 4. According to the first option, air is introduced into the mixer through a line 63. A blower 64 may be provided in the line to provide the necessary pressure of the air. According to the second option, air is introduced into an air separation unit 65 through a line 66. The air separation unit 65 may be any kind of air separation unit known in the art that can produce oxygen or oxygen enriched air. The oxygen enriched air or oxygen is withdrawn from the air separation unit through a line 67 and introduced into the mixer 62, whereas oxygen depleted air is released into the atmosphere from the air separation unit through a line 68. The gas in line 67 is preferably oxygen enriched air having a concentration of oxygen above 50%. The oxygen requirement is dependent on the oxygen content in the exhaust gas from the thermal power plant 50. The exhaust gas composition is dependent on the load on the gas turbine and supplementary gas firing in the exhaust gas. A convenient, and cost effective air separation unit for this purpose is a membrane based separation unit. The two options for addition of oxygen may be combined, i.e. both air and oxygen may be introduced through lines 63 and 67, respectively.

The gas from the mixer 62 is withdrawn through a line 69 and introduced into combined plant for thermal power production and CO₂ capturing 70. The combined plant is preferably a plant according to WO 00/57990 or WO 2004/001301, both to the same applicants, or an alternative embodiment thereof described in further detail below.

The gas entering the combined plant 70 through line 69 is used as an oxygen containing gas for combustion under elevated pressure of natural gas entering the plant 70 through a line 71. Electrical power, and optionally heat, is exported from the plant 70 in a line 72. The exhaust gas from the combustion in the combined plant 70 is separated to a CO₂ stream leaving the plant through line 73, and a CO₂ depleted stream that is released into the atmosphere through a line 74.

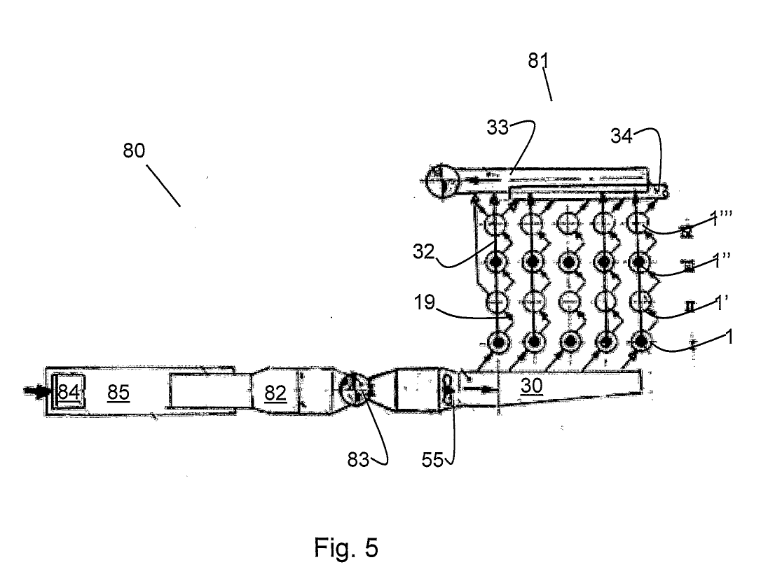

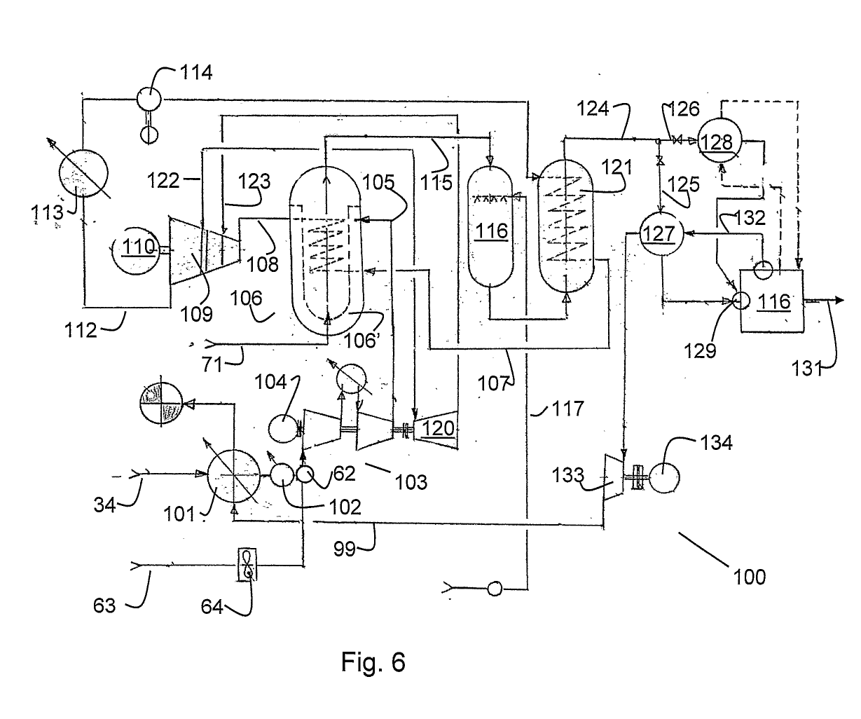

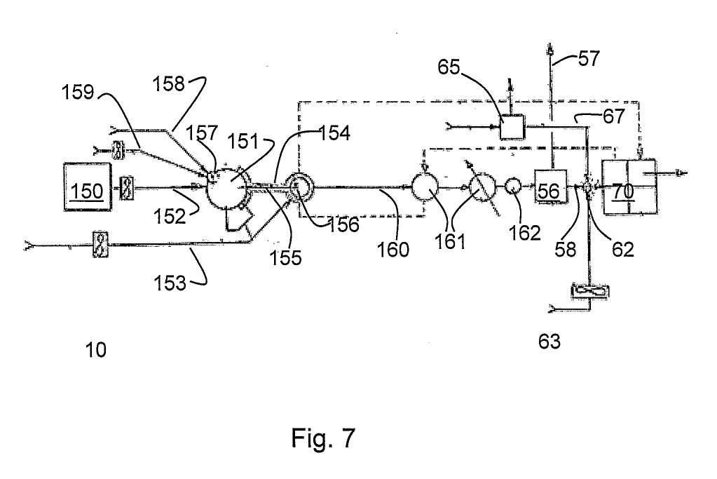

FIG. 6 illustrates an alternative embodiment of the combined plant for thermal power production and CO₂ capturing than the ones described in the above mentioned WO applications of the present applicants. An exhaust gas comprising CO₂, N₂ and O₂, preferably a gas that has been enriched in CO₂ by means of the present gas separation unit, is introduced through a line 34 into a heat exchanger 101, in which the exhaust gas is cooled by heat exchanging against CO₂ depleted gas in a line 99. The gas cooled in the heat exchanger 101 may be even further cooled in a cooler 102 before it is mixed with air or oxygen in a mixer 62. The introduction of air of oxygen is in the figure illustrated by a line 63 and a blower 64 for introduction of air. Oxygen from a air separation unit 65 may, however, be introduced as described through a line 67. The air separation unit and line 67 is omitted in FIG. 5.

After mixing of air and the cooled gas from line 34, the combined gas flow is entered into a compressing unit 103, comprising one or more compressors and optional intercooler(s). The compressing unit is operated by a steam turbine 120. An electrical motor 104 may be provided for starting up the compressing unit and turbine after a stop.

The compressed gas mixture leaving the compressor unit 103 is carried in a line 105 and introduced into a combustion chamber 106, where natural gas, introduced from line 71, is combusted at an elevated pressure using the compressed gas mixture as an oxygen containing gas. The pressure in the combustion chamber is preferably between 5 and 20 bar, such as from about 8 bar to about 16 bar, such as e.g. about 10 bar. As indicated in the figure, the compressed gas may be introduced into a mantle 106′ surrounding at least the combustion chamber, to cool the outer walls of the combustion chamber and to heat the compressed gas before it is introduced into the combustion chamber.

In the combustion chamber 106 steam is generated in a closed tubular system connecting a water inlet line 107 and a steam line 108. It is preferred that the temperature in the combustion is reduced by generation of steam so that flue gas leaving the combustion chamber through a flue gas line 115, has a temperature below about 400° C., e.g. about 350° C. By reducing the temperature of the flue gas to about 350° C., the requirement for high cost, high grade steel for the succeeding equipment is omitted. An exemplary combustion chamber for use in the present plant is described with reference to FIG. 3 in WO2004001301.

The steam leaving the combustion chamber through the steam line 108, is expanded over one or more steam turbine(s) 109. Electrical power is generated from the steam turbine(s) 109 in an electrical generator 110.

Low temperature steam is released from the turbine(s) 109 in a line 112 and is cooled and finally condensed in one or more heat exchanger(s) 113 and cooler(s) 114. The condensed water may again be partly reheated in an economizer 121, before the water again is reintroduced into the combustion chamber through line 107.

A part stream of the steam in steam turbine 109 may be withdrawn through a line 122 to be introduced into the turbine 120 to operate the compressor unit 103. Partly expanded steam from the turbine 120 may then again be reintroduced into the turbine 109 through a line 123

The flue gas that is withdrawn through line 115 may, if required, be introduced into a selective catalytic reduction (SRC) unit 116 in which an aqueous solution of a reductant, such as ammonia or urea, is introduced through a line 117 in a way known by the skilled man in the art. The temperature of the flue gas is reduced by evaporation of the water including the reductant in the SCR unit 116. The temperature of the flue gas is further reduced in the above mentioned economizer 121 downstream to the SCR unit, against condenced water from the heat exchanger 113 and cooler 114. The flue gas leaving the economizer has a temperature of about 170° C., and is withdrawn through a line 124.

The flue gas in line 124 is split in a line 125 which is further cooled in a heat exchanger 127, and a line 126 which is further cooled in a cooler 128. Both streams are cooled to a temperature of about 90° C., before they are introduced into a condenser 129 before being introduced into a CO₂ capturing plant 130.

The CO₂ capturing plant 130 is of the adsorption/resorption type as described in the above mentioned WO publications from the applicant. The preferred absorbent is an aqueous carbonate solution.

CO₂ that is captured in the plant is withdrawn through a line 131 for export from the plant, whereas the not captured gas, being low in CO₂ is withdrawn through a line 132.

The gas in line 132 is heated in the heat exchanger 127 against the gas in line 125, and is expanded over a turbine 133 to produce electricity in a generator 134. The low temperature gas is withdrawn from the turbine 133 in a line 99 and may be used to cool the incoming gas in line 34 in the heat exchanger 101 before the gas is released into the atmosphere through the line 74.

An important feature with the plant described with reference to FIG. 6 is that the flue gas in the combustion chamber is cooled to below 400° C. before leaving the combustion chamber. Accordingly, the gas turbine that is described as essential parts in above mentioned WO publications of the present applicants, may be omitted without loosing efficiency. This makes it practically possible to scale the plant more easily for different purposes.

The efficiency of absorption in the CO₂ capturing plant is assumed to be proportional to the partial pressure of CO₂ up to the maximal absorption capacity of the plant. The CO₂ capturing plant is dimensioned to the CO₂ load from the combusted carbonaceous fuel. By reducing the total gas load and increasing the concentration, or partial pressure, of CO₂ the efficiency of the capturing becomes higher than it would be for the untreated exhaust gas at atmospheric pressure. This makes it possible to use carbonates as absorbents in stead of the more efficient amines. Carbonates are relatively inexpensive, does not give raise to toxic waste or unpleasant smell from the plant. Additionally, the carbonates are not, as the amines, prone to deactivation by oxygen and other constituents of the exhaust gas.

### Examples

The present invention will now be described in further detail with reference to plants in which the present invention may form a part to increase the CO₂ capturing or to reduce the cost thereof.

### Example 1

FIG. 5 illustrates a combined heat and power plant 80 connected to a CO₂ enrichment plant 81. The combined power and heat plant 80 is illustrated by a gas turbine 82, heat exchange means 83 and a flue gas manifold 30. A plurality of centrifuges 1, 1′, 1″, 1′″ are connected in centrifuge trains in which four centrifuges are connected in series. Several compressor trains are parallel arranged between the flue gas manifold and a light gas manifold 33 and a manifold for CO₂ enriched gas 34 as described with reference to FIG. 3.

The plant according to this example comprises two units according to FIG. 5, in a plant as illustrated in FIG. 4. Each unit according to FIG. 5, comprises a 130 MW gas turbine, resulting in a exhaust gas flow of 400 m³/sec, giving a total effect of 260 MW and a total exhaust gas volume of 800 m³/sec.

Each unit has its own CO₂ enrichment plant 81 comprising 5 parallel centrifuge trains, each with four centrifuges in series. The centrifuges are preferably identical with the exception of the diameter of the light gas outlet pipe 22.

The rotary part of each centrifuge is a conical tubular construction having a mean diameter of 3.30 m, a maximum diameter of 3.60 m and an effective height of 20 m. The rotary part is rotated at a speed of 1800 rpm to give a maximum radial force of 6513 G.

Due to the large radial G-force, the tubular body must be built of a material with light weight and high strength. An example of a material that may be used for the tubular body 12 is a titan alloy of the composition TiAl5Cr2Mo2.

The partial pressure of gaseous components in a centrifuge, assuming a solid body rotation, is given from the Maxwell-Bolzmann Distribution Law:

α=exp((M₂−M₁)(Ωr)²/2RT), where Eq. 1

M₂ and M₁ are the molecular weight of CO₂ and N₂, i.e. 44 and 28, respectively.

Ω=angular velocity

r=radius from center of rotation

R=gas constant

T=temperature (° K)

This results in the following equation for exhaust gas separation:

α=exp((44−28)(188.4×1.80)²/2×8314.3×293=1.46

Using a centrifuge where the diameter of the shaft gradually increases the first 25% of the length of the centrifuge, i.e. the first 5 meters, and then decreases again, the effective axial separation length of the centrifuge is 15 meters. The flow delivered to the first centrifuge in the centrifuge train is 400 m³/sec/5=80 m³/sec. The average cross section area in the effective part of the centrifuge is 9.14 m², and the axial exhaust gas velocity is 8.75 m/sec, giving an exhaust gas retention time in the effective part of the centrifuge of 1.71 m/sec.

Based on the gas concentration ratio and the retention time as calculated above, it is expected that a separation ratio of 20% can be achieved for N₂ and O₂, together with 2% of the CO₂ for the first of the serially connected centrifuges. For the succeeding serially connected centrifuges the retention time will increase due to reduced mass flow.

Table 1 is an overview over critical parameters in one train of centrifuges.

| | Centrifuge No. | | | | |
|---|---|---|---|---|---|
| | I | II | III | IV | Total |
| Flue gas to centrifuge | 80 | 62 | 44 | 26 | |
| inlet | | | | | |
| Nitrogen rich gas to | 18 | 18 | 18 | 18 | 72 |
| atmosphere (m³/s) | | | | | |
| CO₂ enriched gas | 62 | 44 | 26 | 8 | |
| out of centrifuge | | | | | |
| (m³/s) | | | | | |
| Axial flow velocity in | 8.6 | 6.7 | 4.7 | 2.8 | |
| centrifuge (m/s) | | | | | |
| Retention time (s) | 1.7 | 2.2 | 3.2 | 5.4 | 12.5 |
| Separation ratio | 0.22 | 0.29 | 0.41 | 0.69 | |
| Nitrogen rich gas | 2.04 | 2.69 | 3.81 | 6.41 | |
| exit area (22) (m²)* | | | | | |
| Power requirement | 440 | 341 | 242 | 143 | 1166 |
| (motor) (KW) | | | | | |
| Temperature | 4.5 | 3.5 | 2.5 | 1.5 | 12 |
| increase (° C.) | | | | | |
| Concentration | 1.02 | 1.03 | 1.04 | 1.06 | 1.158 |
| ratio O₂/N₂** | | | | | |

*Pipe segment arranged upstreams line 22
**Eq. 1

The composition of the exhaust gas entering the first centrifuge in the centrifuge train (centrifuge I); 80 m³/sec, is as follows:
O₂ 8.80 m³/sec, 9.68 kg/sec
CO₂ 2.84 m³/sec, 4.35 kg/sec
N₂ 68.36 m³/sec, 66.30 kg/sec

Ratio O₂/N₂=8.80/68.36=0.129

The composition out of the last centrifuge in the centrifuge train (centrifuge IV), 8 m3/sec, delivered to line 34, is as follows:
CO₂ 2.67 m³/sec
N₂+O₂; 8.00−2.67 m³/sec=5.33 m³/sec

Ratio O₂/N₂ adjusted for concentration ratio;

Ratio O₂/N₂=0.129×1.158 kg/sec=0.149
O₂; 0.79 m³/sec-0.87 kg/sec
Total flow of separated exhaust gas; 80.0 m³/sec
O₂ content in the separated exhaust gas; 7.9 m³/sec
Combustion flow in line 69 required for the combined plant for thermal power production and CO₂ capturing 70 of 100 MW; 96 m³/sec
O₂ required in line 69 for introduction into plant 70; 20.2 m³/sec
Additional O₂ required; 20.2−7.9 m³/sec=12.3 m³/sec, to be added as:
   Additional air in line 63: 6.2 m³/sec—O₂; 1.3 m³/sec
   Additional O₂ in in 67; 11.0 m³/sec, 12.1 kg/sec.

The amount of O₂ required for combustion in the plant 70 is governed by the load on the power plant 50, and the supplementary gas firing in the plant 70. The supplementary firing is not energy efficient, and could be replaced by low energy heat delivered from the plant 70.

The combustion and CO₂ capturing in the plant 70 is operated under elevated pressure as described in further detail in WO 2005/045316, such as e.g. at 11 bar.

The CO₂ partial pressure in line 69, i.e. at substantially atmospheric pressure, is 26.7/96.0=0.278

The partial pressure of CO₂ in the gas that is introduced into the CO₂ absorption column is 3.06 bar.

The partial pressure ratio for CO₂ in the exhaust gas introduced into the absorption column absorption to the CO₂ in the exhaust leaving the thermal power plant 50 is 3.06/0.04=76.5.

The CO₂ enriched gas in line 34, 58, may then be introduced as an oxygen containing gas into a combined CO₂ capturing plant and power plant 70 as described in WO

### Example 2

FIG. 7 illustrates an exemplary plant for treatment of flue gas from an aluminum factory 150. Flue gas from the aluminum factory 150 is introduced as a fuel into a ground burner 151 through a line 152. The flue gas contains CO that is used as fuel in the ground burner and is burned at a temperature above 700° C. Air is introduced through an air line 153 into a cooling mantle 154 partly surrounding the ground burner 151, an exhaust gas line 155 for transferring exhaust gas from the ground burner to a economizer 156, and the economizer to cool the economizer, the transfer line and a part of the ground burner. The heated air in the mantle is then introduced into the ground burner as oxygen containing gas for the combustion therein.

A gas burner 157, fed by natural gas from gas line 158 and air from air line 159, is provided in the ground burner 151, both to ignite the ground burner to start the combustion of CO, and to withheld a temperature high enough to ascertain combustion of CO.

The flue gas leaving the economizer 156 through a line 160, is cooled by means of heat exchangers/coolers 161 before it is introduced into a CO₂ enrichment plant 56, comprising centrifuges as illustrated above. In the CO₂ enrichment plant, the low weight gas, that is low in CO₂, is released to the atmosphere through line 57, whereas the CO₂ enriched gas is withdrawn through line 58. The gas from line 58 is mixed with air from line 63, or with oxygen or oxygen enriched air from an air separation unit 65, in a mixer 62. After the mixing with air the flue gas is introduced into a combined plant 70 as describe above. A fluorine abatement unit 162 is preferably provided to remove fluorine from the flue gas before the CO₂ enrichment unit.

In an exemplary aluminum factory 150, a total flue gas flow of 555 m³/s is produced, the flue gas comprising about 4% CO and 8.6 kg/sec CO₂. Traditionally, the flue gas is released into the atmosphere after removal of fluorine. The CO in the flue gas that represents a potential useable energy potential of about 150 MW, is released into the air where it is further reacted with oxygen to form CO₂.

The combustion of CO will generate about 34.0 kg/sec of CO₂ and will together with the CO₂ already in the flue gas, give a total of 42.6 kg/sec or 1.343 Mt/y. It is expected that the price of quota for release of CO₂ will be about NOK 100/t. Having CO₂ quota at this price combined with the price of electrical energy and heat energy from the plant 70, will give a net income in the order of about NOK 270 Mill per year at an estimated investment of 3.0 billion NOK.

1. A method for enrichment of CO₂ from a gas mixture comprising at least CO₂ and nitrogen, comprising the steps of:
a) introducing the gas mixture into a centrifugal separation device separating the gas mixture based on the molecular weight of the gases therein in a centrifugal field created by rotation of the gas mixture about an axis of rotation in a centrifuge or cyclone,
b) withdrawing a low CO₂ stream close to the axis of rotation and a CO₂ enriched stream is withdrawn close to the periphery of rotation,
c) releasing the low CO₂ stream into the surroundings,
d) introducing the stream enriched in CO₂ from one centrifuge or cyclone into a next centrifuge or cyclone, and
e) withdrawing a low CO₂ stream, that is released to the surroundings, and a CO₂ enriched stream from this next centrifuge or cyclone.

2. The method according to claim 1, wherein steps d) and e) are repeated one or more times.

3. The method according to claim 1, wherein the gas mixture is exhaust gas from a fossil fuel fired power plant or other industrial plant.

4. A method for separation of CO₂ from a gas mixture comprising at least CO₂ and nitrogen, comprising the steps of:
a) introducing the gas mixture into a centrifugal separation device separating the gas mixture based on the molecular weight of the gases therein in a centrifugal field created by rotation of the gas mixture about an axis of rotation in a centrifuge or cyclone,
b) withdrawing a low CO₂ stream close to the axis of rotation and a CO₂ enriched stream is withdrawn close to the periphery of rotation,
c) releasing the low CO₂ stream into the surroundings,
d) introducing the stream enriched in CO₂ from one centrifuge or cyclone a next centrifuge or cyclone,
e) withdrawing a CO₂ low stream, that is released into the surroundings, and
f) withdrawing a CO₂ enriched stream,
g) introducing the CO₂ enriched stream into a absorption device for separation into a CO₂ lean gas that is released into the surroundings, and CO₂.

5. The method according to claim 4, wherein steps d), e) and f) are repeated once or more.

6. A method for separation of CO₂ from a gas mixture comprising at least CO₂ and nitrogen, comprising the steps of:
a) introducing the gas mixture into a centrifugal separation device separating the gas mixture based on the molecular weight of the gases therein in a centrifugal field created by rotation of the gas mixture about an axis of rotation in a centrifuge or cyclone,
b) withdrawing a low CO₂ stream close to the axis of rotation and a CO₂ enriched stream is withdrawn close to the periphery of rotation,
c) releasing the low CO₂ stream into the surroundings,
d) introducing the stream enriched in CO₂ from one centrifuge or cyclone a next centrifuge or cyclone,
e) withdrawing a CO₂ low stream, that is released into the surroundings, and
f) withdrawing a CO₂ enriched stream,
g) cooling and mixing the CO₂ enriched stream with air and/or oxygen;
h) compressing the combustion gas—air/oxygen mixture;
i) reheating the compressed gas from step h) by using it as an oxygen containing gas for combustion of natural gas in a pressurized combustion chamber to form an exhaust gas;
j) regulating the supply of natural gas and oxygen containing gas in the combustion chamber so that the exhaust gas contains less than 6% rest oxygen;
k) keeping the temperature in the exhaust gas below 400° by generation of steam in tubular coils in the combustion chamber;
l) cooling the exhaust gas and separating the exhaust gas into a CO₂ depleted stream and CO₂.

7. The method according to claim 6, wherein the CO₂ depleted stream is reheated by means of heat exchanges against the hot exhaust gas leaving the combustion chamber, and is thereafter expanded in turbines.

8. A plant for enrichment of CO₂ from a gas comprising nitrogen and CO₂, the plant comprising two or more centrifuges or cyclones separating the gas based on the molecular weight thereof in a centrifugal field, means to withdraw and release into the surroundings, a low molecular weight, or low CO₂ stream close to the axis of rotation of the axis of rotation of the centrifugal field, and means to withdraw a CO₂ enriched stream from the periphery of the centrifugal field, and means to transfer the CO₂ enriched stream from one centrifuge or cyclone to a next centrifuge or cyclone in a serially connected row of two or more centrifuges or cyclones, and means to withdraw the CO₂ enriched gas stream from the last centrifuge or cyclone in the row of serially connected centrifuges or cyclones and transfer the gas to means for further treatment.

9. The plant according to claim 8, wherein the plant comprises two or more rows or serially connected centrifuges or cyclones arranged in parallel.

10. A plant for capturing, or separating, CO₂ from a CO₂ containing gas, the plant comprising a plant according to claim 8 for enrichment of CO₂ and absorption means to separate the CO₂ enriched gas into a CO₂ depleted stream that is released to the surroundings, and CO₂.

11. A plant for capturing, or separating, CO₂ from a CO₂ containing gas, the plant comprising a plant according to claim 8 for enrichment of CO₂, means for cooling and mixing the CO₂ enriched stream with air and/or oxygen, means for compressing the combustion gas—air/oxygen mixture; a combustion chamber for reheating the compressed gas by using it as an oxygen containing gas for combustion of natural gas in a pressurized combustion chamber to form an exhaust gas; means for regulating the supply of natural gas and oxygen containing gas in the combustion chamber so that the exhaust gas contains less than 6% rest oxygen; tubular coils arranged in the combustion chamber for keeping the temperature in the exhaust gas below 400° by generation of steam in the tubular coils; means for cooling the exhaust gas; and absorption means for separating the exhaust gas into a CO₂ depleted stream and CO₂.

12. The method according to claim 2, wherein the gas mixture is exhaust gas from a fossil fuel fired power plant or other industrial plant.
